(19) United States
(12) Patent Application Publication
(10) Pub. No.: US 2005/0181332 A1
(43) Pub. Date: Aug. 18, 2005

(54) Lingual retainer

(75) Inventor: Friedrich Sernetz, Pforzheim (DE)

Correspondence Address: LEYDIG VOIT & MAYER, LTD, 700 THIRTEENTH ST. NW, SUITE 300, WASHINGTON, DC, 20005-3960, US

(73) Assignee: Dentaurum J. P. Winkelstroeter KG, Ispringen (DE)

(21) Appl. No.: 11/083,088

(22) Filed: Mar. 18, 2005

Related U.S. Application Data
(63) Continuation of application No. PCT/EP03/10478, filed on Sep. 19, 2003.

(30) Foreign Application Priority Data
Sep. 20, 2002 (DE) 102 45 008.0

(51) Int. Cl. A61C 13/225

(52) U.S. Cl. 433/180

(57) ABSTRACT

The invention relates to a lingual retainer which can be connected at both ends to the teeth of a patient by means of an adhesive connection in order to maintain the position of the corrected teeth of the patient in said corrected position. The retainer avoids known problems encountered with conventional material and also exhibits good flexibility as well as good biocompatibility and a high patient comfort. It can also be used over a long period of time (in extreme cases, for a lifetime) without any detrimental effects on health. The retainer is made of one material which is either titanium or a titanium alloy.

This application is a continuation of International Application No. PCT/EP03/10478, filed Sep. 19, 2003, which is incorporated herein by reference.

The invention relates to an orthodontic appliance in the form of a lingual retainer comprising a bow that can be attached at both ends to the teeth of a patient by means of a cement bond, in order to keep the patient's teeth in position following corrective treatment.

The purpose of lingual retainers is to keep teeth in a new, corrected position following orthodontic treatment and to stabilize this position. Lingual retainers are usually bonded to the teeth on the non-visible (lingual) surface thereof.

Prior art lingual retainers consist, for example, of a bow made of, say, a non-annealed Co/Cr alloy, as this alloy ensures that the brace is sufficiently pliable to enable the bonding regions to be positioned to fit well against the surface of the teeth. The bonding regions are produced by soldering so-called metal mesh pads of, e.g., stainless steel to the ends of the bow.

The main disadvantages of this kind of lingual retainer comprise the use of different metals or alloys and the fact that the metal mesh pad is joined to the bow by soldering, as a result of which the resistance to corrosion or the biocompatibility of the retainer is substantially reduced. Furthermore, the bonding regions increase the overall thickness and reduce patient comfort.

It is an object of the present invention to provide a lingual retainer showing good pliability and biocompatibility while avoiding the aforementioned material-dependent problems and affording enhanced patient comfort, thereby allowing it to be worn for prolonged periods (in extreme cases for a lifetime) without causing health-related side effects.

This object is achieved, according to the invention, by fabricating a lingual retainer of the type defined above from a single material selected from the group consisting of titanium and titanium alloys.

Retainers of the present invention made from titanium or titanium alloys are highly biocompatible and can thus be used for very long periods of time without causing any adverse health-related side effects.

Furthermore, titanium or titanium alloys are materials that are of low rigidity (low modulus of elasticity), are pliable, having a low elastic limit, and can be readily bonded to teeth.

In a variant of the retainer of the invention, the bow has a bonding region at each end thereof, by means of which it can be bonded in a simple and accurate manner to the patient's teeth.

Alternatively, simple retainers can be used, these being composed of a bow only and often consisting of a (frequently multistrand) wire, the elastic limit of which is so low that it is pliable. These simple bows not equipped with bonding regions are bonded as such to the lingual surface of the teeth to be stabilized.

Within the scope of the present invention, bonding is understood to mean any kind of connection that adhesively joins materials together. Specifically, a bond can be created using any of the standard cements employed in dentistry, particular examples of which for use in the present context are glasionomer cements.

These retainers can also be specially prepared for bonding by providing them with specially prepared surface regions at the sites where they are to be bonded to the patient's teeth. In the simplest case, these would be surface regions located at each end of the bow. This bow more preferably has on its side designed to face the surface of the teeth one or more additional surface regions prepared for bonding to teeth.

The preparation of the surface region for bonding purposes may consist of roughening, for example. Roughening can be accomplished by etching, sandblasting, laser machining, or by mechanical machining, such as embossing or metal cutting.

The retainer is preferably produced with its bow and the two bonding regions forming a unitary structure. If desired, the bonding regions may be adapted to provide an enlarged surface area for bonding the retainer to the teeth.

The bow more preferably has substantially the same thickness as the bonding regions, and the transition between the bow and the bonding regions is such that the bow substantially merges with the bonding region or is attached thereto in flushed relationship. In this way the bonding regions do not increase the overall thickness, and patient comfort is enhanced.

With respect to this requirement as well as to the need for the simplest possible manufacturing process, the retainer is preferably made from sheet metal, e.g., by stamping.

The entire retainer, that is, the bow including the bonding regions at its ends, is thus stamped from the sheet metal, or else fabricated therefrom in some other way, so that the retainer has consistent thickness. The necessary residual rigidity is set by the occlusal-gingival dimension of the bow.

In another preferred embodiment, the bow of the retainer is made from multi-strand wire. In this case, a plurality of wire filaments is stranded to form a wire. The individual filaments may be of the same or different types. Thus it will be a very simple matter for the person skilled in the art to produce retainers having the desired mechanical properties mentioned above, not only by varying the number of filaments used, but also by selecting them according to their mechanical strength values. In this regard, not only the diameter of the individual filaments, but also their composition, can be varied so that, for example, a number of filaments of various similar titanium alloys can be used. This meets the demand for biocompatibility forming one of the objectives of the invention.

Advantageous retainers can be produced from half-round or half-oval profiled materials, and the surface regions required for bonding purposes can be formed on the flat side of the bow.

This avoids the presence of projections and depressions on the retainer, which are detrimental to oral hygiene, and result, inter alia, in improved patient comfort, because the tongue, which can detect very small uneven regions, will only come into contact with a material that is substantially uniformly thick and thus smooth.

The bonding regions are preferably roughened on the surface to be bonded.

Various methods are recommended for roughening the relevant surfaces of the bonding regions, such as sandblasting, chemical etching or, in particular, laser structuring, that is, machining with a laser ray, as disclosed in EP 0 841 877 B1.

The titanium or titanium alloy lingual retainers of the invention can be fabricated in particular as a unitary structure without involving soldering or the use of additional metal mesh pads or other supplementary materials, so that the high degree of biocompatibility of titanium and titanium alloys can by fully exploited.

An advantage of titanium and titanium alloys is that they have a low modulus of elasticity, so that the lingual retainer itself will react with only a low restoring force to any possible deflection thereof by the tooth to be held in place. This is assisted by the pliability, i.e., the low elastic limit, of titanium and titanium alloys, which makes the shape of the bow readily adaptable to the topology of a patient's mouth.

The flat form, which is preferred, is easy to produce by manufacturing the lingual retainer from a titanium or titanium alloy sheet metal, e.g., by stamping or cutting.

In the latter case especially, the bonding region is formed flush with the bow and is thus not made thicker by any soldered-on metal mesh pad.

The previously mentioned method of laser structuring (EP 0 841 877 B1) creates an adequate number of retention sites, which is conducive to a lifelong, durable adhesive bond.

These and other advantages of the invention are explained in greater detail below with reference to the drawings, in which:

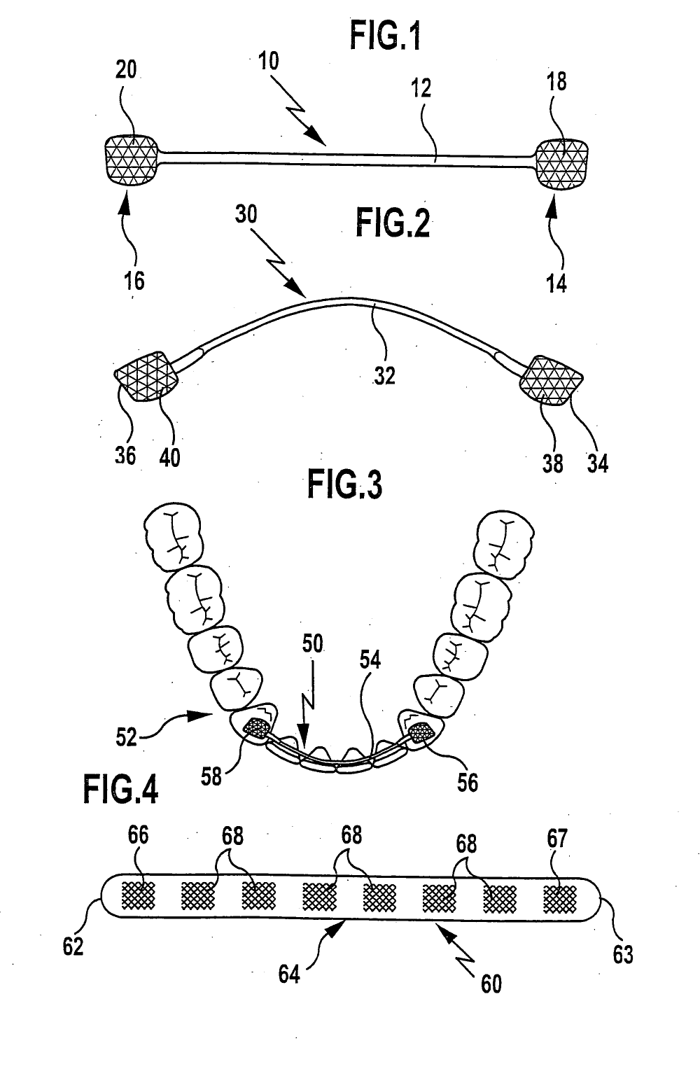

FIG. 1: shows an initially unbent embodiment of a lingual retainer of the invention;

FIG. 2: shows another variant of the lingual retainer of the invention;

FIG. 3: is a diagrammatic representation of a lingual retainer of the invention attached to the lower jaw of a patient; and

FIG. 4: shows another embodiment of the lingual retainer of the invention.

FIG. 1 illustrates a lingual retainer made of, e.g., a titanium alloy, designated as a whole by the reference number 10. Lingual retainer 10 consists of a profiled bow 12 and two bonding regions 14, 16 formed one at each end thereof.

Lingual retainer 10 illustrated in FIG. 1 is stamped from a titanium alloy sheet as a unitary structure, i.e., bonding regions 14 and 16 are integral with bow 12. Furthermore, lingual retainer 10 is of consistent thickness over its entire length, and this promotes oral hygiene and, since there are no recesses or protuberances which could disturb the tongue, enhances the patient comfort.

Bonding regions 14 and 16 are roughened on their surfaces 18 and 20 respectively in preparation for bonding the same to a patient's tooth, said roughening being in the form of a grid-like laser structure. It is therefore not necessary to solder on a metal mesh pad, as otherwise necessary, which is not only an advantage with regard to the biocompatibility of the lingual retainer of the invention, but also reduces the number of production steps, since laser structuring is much easier to accomplish and is more economical. Furthermore, corrosion problems are avoided, since the incorporation of additional materials other than titanium or titanium alloys is no longer necessary due to the type of bonding surface 18 or 20 used.

Alternatively, bonding surfaces 18, 20 may be sandblasted or chemically etched, in which case it is only necessary to ensure that the surface is adequately roughened with, in particular, undercutting thereof, which will ensure secure anchorage of the cement to the bonding regions 18 and 20.

FIG. 2 illustrates another variant of a lingual retainer 30 of the invention, which is composed of a bow 32 and two bonding regions 34, 36. In this embodiment, the bow 32 is welded to the separately manufactured bonding regions, e.g., by laser welding.

Bow 32 is anatomically pre-formed so that the dentist merely has to make slight additional corrections to the shape of the bent bow 32 before placing it in the mouth of a patient and cementing it to the patient's teeth.

The bonding regions 34, 36 have a bonding surface 38 and 40 respectively, which is again laser structured, as described above in connection with FIG. 1.

FIG. 3 is a diagrammatic illustration of a typical attachment situation involving a lingual retainer, for example a lingual retainer 50 comprising a bow 54 and bonding regions 56, 58 formed thereon.

Bonding regions 56, 58 are bonded to the lingual side of, say, the cuspids of the lower jaw 52 of a patient by a cement bond and they maintain said cuspids, as well as the incisors located between them, in the position attained by previous corrective treatment using some other orthodontic device.

FIG. 4 illustrates an alternative embodiment of a retainer 60 of the invention made from a profiled titanium material having a half-round cross section. Unlike the retainers illustrated in FIGS. 1 to 3, the lingual retainer 60 has no enlarged region on the ends 62, 63 of its brace 64 for bonding to the surfaces of the teeth, but instead the surface regions 66, 67 are confined to the flat surface of the half-round profile.

FIG. 4 further illustrates that the lingual retainers of the invention may also preferably have surface regions 68 along their bow at intervals corresponding to the positions of the teeth, which surface regions supplement the surface regions 66 and 67, so that this lingual retainer 60 can, if required, be adhesively attached to each of the teeth supported by bow 64.

1. An orthodontic appliance in the form of a lingual retainer comprising a bow having two ends, wherein the retainer is fabricated from only one material selected from the group consisting of titanium and titanium alloys, the bow having a bonding region having a surface at each of its two ends, and wherein the bonding regions are roughened on the surfaces thereof to be bonded.

2. The appliance as defined in claim 1, wherein the bow and the bonding regions are fabricated as a unitary structure.

3. The appliance as defined in claim 1, wherein the bow has substantially the same thickness as the bonding regions and the bow is connected to each of the bonding regions by a substantially flush joint.

4. The appliance as defined in claim 2, wherein the bow is fabricated from a sheet metal material.

5. The appliance as defined in claim 1, wherein the bow is fabricated from a multistrand wire.

6. The appliance as defined in claim 1, wherein the roughening of the bonding surface of the bonding regions is produced by sandblasting, etching or laser structuring.

7. The appliance as defined in claim 1, wherein the bow is a profiled bow.

8. The appliance as defined in claim 1, wherein the bow has surface regions at and/or between its ends on that side of its surface which will face the teeth of a patient, which surface regions are roughened for the accommodation of a bonding agent.

9. The appliance of claim 7, wherein the bow exhibits a profile of half-round cross section.

10. The appliance of claim 7, wherein the bow exhibits a profile of half-oval cross section.

11. The appliance as defined in claim 2, wherein the bow has substantially the same thickness as the bonding regions and the bow is connected to each of the bonding regions by a substantially flush joint.

12. The appliance as defined in claim 3, wherein the bow is fabricated from a sheet metal material.

13. The appliance as defined in claim 2, wherein the bow has surface regions at and/or between its ends on that side of its surface which will face the teeth of a patient, which surface regions are roughened for the accommodation of a bonding agent.

14. The appliance as defined in claim 3, wherein the bow has surface regions at and/or between its ends on that side of its surface which will face the teeth of a patient, which surface regions are roughened for the accommodation of a bonding agent.

15. The appliance as defined in claim 4, wherein the bow has surface regions at and/or between its ends on that side of its surface which will face the teeth of a patient, which surface regions are roughened for the accommodation of a bonding agent.

16. The appliance as defined in claim 5, wherein the bow has surface regions at and/or between its ends on that side of its surface which will face the teeth of a patient, which surface regions are roughened for the accommodation of a bonding agent.

17. The appliance as defined in claim 7, wherein the bow has surface regions at and/or between its ends on that side of its surface which will face the teeth of a patient, which surface regions are roughened for the accommodation of a bonding agent.

18. The appliance as defined in claim 9, wherein the bow has surface regions at and/or between its ends on that side of its surface which will face the teeth of a patient, which surface regions are roughened for the accommodation of a bonding agent.

19. The appliance as defined in claim 10, wherein the bow has surface regions at and/or between its ends on that side of its surface which will face the teeth of a patient, which surface regions are roughened for the accommodation of a bonding agent.
